(19) United States
(12) Patent Application Publication
(10) Pub. No.: US 2003/0173098 A1
(43) Pub. Date: Sep. 18, 2003

(54) Portable multipurpose demolition tool

(75) Inventors: Kevin R. Miner, Castleton, NY (US); David J. Wilson, Morrisonville, NY (US)

Correspondence Address: Kevin R. Miner, 1477 Sunset Road, Castleton, NY, 12033, US

(73) Assignee: Evergreen Technologies, LLC, Castleton, NY

(21) Appl. No.: 10/098,468

(22) Filed: Mar. 18, 2002

(51) Int. Cl. B25D 9/00

(52) U.S. Cl. 173/200

(57) ABSTRACT

A hand held portable multipurpose demolition tool is powered by bottled compressed gas operating a pneumatic impact mechanism with interchangeable tools. The compressed gas, gas supply pressure and gas flow rate are variable allowing application of the tool to a large variety of demolition, construction, forcible entry, and ancillary functions.

### BACKGROUND OF THE INVENTION

1. Field of the Invention

This invention relates to the field of portable hand held impact tools, and more specifically, this invention relates to a portable hand held tool, powered by compressed gas for specific use as a demolition and multipurpose impact tool.

2. Description of the Prior Art

Impact tools powered by compressed gases are common and are used in a large variety of applications including asphalt, concrete and rock splitting, metal cutting, and demolition of structures. Most pneumatic powered impact tools rely upon a separate compressed gas, usually air, source such as a compressor with its associated mobility and use limitations. Use of bottled compressed gases allows the operation of these impact tools in remote, confined spaces without the need for ancillary equipment.

Referenced U.S. Pat. No. 4,750,568, “Pneumatic Rescue Tool”, relates to the use of a pneumatically powered impact device to be used specifically as a rescue tool. This invention broadens the capability of a compressed gas powered impact device to be used as a portable multipurpose tool primarily in the demolition field but it has a wide variety of additional functions.

### SUMMARY OF THE INVENTION

a. Advantages Over the Prior Art

Compressed or liquefied inert gas provides potential energy source as apposed to a heavy and awkward portable hydraulic power supply, dangerous propellant actuated devices, heavy battery power supplies, air compressors, or other current state-of-the-art power sources. Using bottled compressed gases as a power source for a portable demolition tool will provide tremendous advantage over current demolition tools by allowing users to get into tight spaces without the need for an air hose or compressor or allow use in awkward situations where lightweight and agility is required such as on scaffolding or crawl spaces.

Other advantages include the elimination of the need for an expensive air compressor or the time required to set it up. All portable multipurpose demolition tool components are easily packaged into a low volume, lightweight portable package.

As a portable compressed gas powered impact tool, this invention allows for a vast range of uses beyond previous prior art devices used solely as a “rescue tool”. This invention solves the problem of providing a lightweight convenient and portable means of powering a conventional or future pneumatic demolition tool for minimum operational costs.

b. Known or Possible Uses Include:

This invention can be used to break or cut a large variety of materials including wood, metal, wire, rebar, rock, or brick masonry items without the need for an external air compressor. It can be used as a rescue tool to free personnel trapped in vehicles, residential or commercial structures. It can be used as a general construction or demolition tool where portability is desired or required.

Examples of other uses for the invention with simple design modifications include the ability to easily and conveniently remove wheel nuts from vehicles or operate a conventional vehicle screw jack without the need for an air compressor or it's associated air hoses. This is an especially attractive feature for highway assistance operators, state police officers, or persons of limited capacity who would otherwise be incapable of manually removing or installing vehicle wheel nuts or operating a conventional vehicle screw jack.

The invention can be used to provide an impact action to a particular construction, demolition, law enforcement or emergency rescue tool. It can be used to forcible open secured or blocked doors, barred windows, light steel structures and other entry/exit points within a residential or commercial structure. This can be accomplished within a matter of a few seconds allowing the rapid entry/egress of law enforcement, military, firefighter or other personnel

The stored inert gas, through a special tool feature, can be used in an emergency situation to provide fire suppressant capabilities. This is particularly attractive to highway emergency and law enforcement personnel as a readily available emergency tool as it is being used for other functions. Also in an emergency situation, through a special tool feature, the stored inert gas can be used to inflate items such as tires, floatation devices, signal balloons, etc.

Military uses of the invention will improve the soldier's effectiveness by providing the capability to perform many essential tactical functions especially in urban environments and conditions. By allowing the soldier to rapidly gain access to structures by breaching structural doors and masonry walls, survivability will be increased. Use of the invention will enable the soldier to perform battlefield engineering, demolition, and rapid entry functions with minimal weight or logistics burden. Being an excellent tool for use in confined spaces, the invention can quickly chisel a man-sized hole in a brick, poured or block concrete wall in crawl spaces, tunnels, elevated positions, or other difficult environments. In addition, rapid entry can be gained into vehicles, outbuildings, and locked containers. Rescue operations can be easily performed from downed aircraft, conventional and lightly armored vehicles if required.

As a field engineering tool the invention will facilitate the rapid cutting of holes in masonry for the implantation of explosives or mines. It can be used to cut bolt heads, sever fasteners, and drive out pins of conventional construction to enable the quick disassembly, weakening or destruction if desired.

Special cutters used for rapid cutting of steel rebar and cable may also be used to quickly and effectively destroy weapons such as rifles, pistols and field equipment. The chisel tips may also be used in “demil” or sabotage applications by puncturing tires, engine oil pans, and damaging weapon systems mechanisms.

By using a special access port, the compressed gas of the invention may also be used in emergency situations to inflate tires, blow up rubber decoys, and act as an emergency fire extinguisher.

c. Features Believed to be Novel

Use of liquefied or compressed gases in either a small volume onboard tank or a large volume external tank is used in conjunction with conventional or specially designed gaseous mechanisms to provide a portable multipurpose tool capability. The capability will allow the user to access remote, confined, or awkward environments and perform a variety of functions.

### BRIEF DESCRIPTION OF THE DRAWING

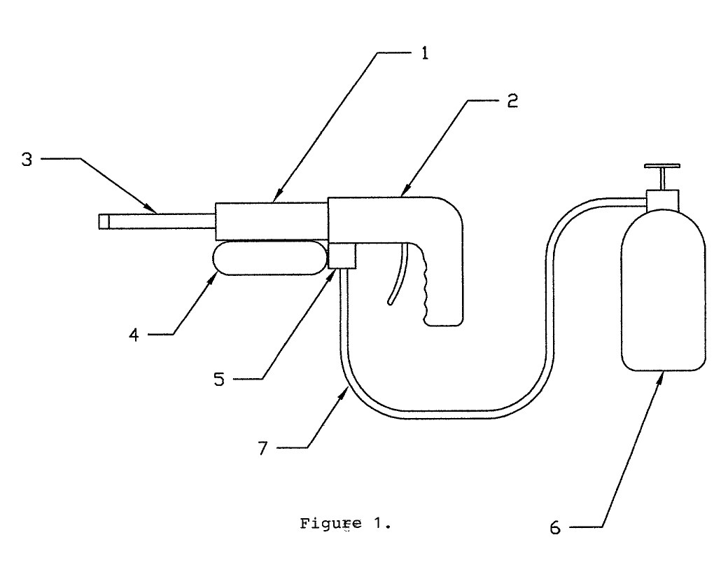

The attached drawing shown in FIG. 1 is a representation of the portable multipurpose demolition tool main components.

### DETAILED DESCRIPTION OF THE PREFERRED EMBODIMENT

The attached drawing shown in FIG. 1 is a representation of the portable multipurpose demolition tool main components. A Pneumatic Impact Mechanism 1 is attached or integral to a Handle and Trigger Assembly 2. Attached to the Pneumatic Impact Mechanism 1 is an Interchangeable Tool Insert 3 that is chosen for the particular task to be performed. An Integral Compressed Gas Tank 4 is attached to the Pneumatic Impact Mechanism 1 or Handle and Trigger Assembly 2 and contains liquefied compressed gas to power the invention.

Stored compressed gas is transferred from the Integral Compressed Gas Tank 4 to the Pressure Regulator Assembly 5 through hard or flexible gas passage lines whereas the compressed gas pressure is modified to the desired operating pressure through the use of an external control feature. The rate of gas passage from the Pressure Regulator Assembly 5 to the Pneumatic Impact Mechanism 1 is controlled by a trigger mechanism in the Handle and Trigger Assembly 2.

In addition to or in place of the Integral Compressed Gas Tank 4 and External Portable Compressed Gas Tank 6 is connected to the Pressure Regulator Assembly 5 with a Flexible Pneumatic Hose 7.

It is understood that variations of this Preferred Embodiment and the exclusion, addition or details of the individual elements disclosed herein may be made without departing from the scope, purpose and function of the invention.

We claim:

1. A hand held pneumatic multipurpose demolition tool capable of operating with a variety of compressed gases over a wide range of operating pressures comprising:
A gas operated impact mechanism attached to hand held features;
A trigger mechanism to operate the tool by allowing the gas to flow to and control the impact mechanism at variable rates;
A pressure regulator to control the gas supply pressure to the tool with a variable pressure control actuator;
An integral compressed gas tank to hold a supply of compressed gas;
An optional external tank to provide an extended supply of compressed gas with a means of conveying gas to the pressure regulator;
A variety of impact and other tools with the associated mechanism to attach them to the gas powered impact mechanism.

2. A hand held pneumatic multipurpose demolition tool capable of operating with a variety of compressed gases and interchangeable tools with, but not limited to, the features and applications including:
lightweight, low volume, portable, multipurpose;
remote, awkward or confined space demolition;
demolition of wood, metal, wire, rebar, rock, brick, masonry or other structural materials and structures, cutting of fasteners and structural elements, driving pins;
forcible entry of vehicles, aircraft, structures, enclosures, containers;
adaptations for rotary tool use allowing tightening or removing fasteners, powering jack lead screws, opening rotary valves, and engine shafts;
compressed gas diversion port to provide a means of inflating tires, balloons, airbags, floatation devices, and operate additional conventional pneumatic tools. Diversion port can also direct compressed gas, especially carbon dioxide, for use as an emergency fire extinguisher;
provide military uses for masonry or wood wall beaching, equipment demolition and sabotage.
